(19) United States
(12) Patent Application Publication
(10) Pub. No.: US 2014/0058658 A1
(43) Pub. Date: Feb. 27, 2014

(54) LOCATION-BASED SERVICE NAVIGATION SYSTEM AND NAVIGATION DISPLAY METHOD THEREOF

(71) Applicants: MITAC INTERNATIONAL CORP., TAOYUAN COUNTY (TW); MITAC RESEARCH (SHANGHAI) LTD., Shanghai City (CN)

(72) Inventors: JIAN-AN WANG, Shanghai City (CN); KAI-MIN XU, Shanghai City (CN)

(73) Assignees: MITAC RESEARCH (SHANGHAI) LTD., Shanghai City (CN); MITAC INTERNATIONAL CORP., TAOYUAN COUNTY (TW)

(21) Appl. No.: 13/755,957

(22) Filed: Jan. 31, 2013

(30) Foreign Application Priority Data
Aug. 23, 2012 (CN) 201210302573.0

(51) Int. Cl. G01C 21/20

(52) U.S. Cl. CPC G01C 21/206
USPC 701/409; 701/408; 701/522

(57) ABSTRACT

This invention discloses a location-based service (LBS) navigation system and a navigation display method thereof. The location-based service navigation system comprises a storage module, a processing module and a display module. Therein, the storage module stores a piece of local information and a local characteristic point based on by a command string. The processing module analyzes the command string of the local information to sequentially draw an indoor map, and the processing module compares the local characteristic point and the local information to analyze a current position. The display module displays the local information, the current position and the indoor map.

### CROSS-REFERENCE TO RELATED APPLICATION

This application claims the benefit of China Patent Application No. 201210302573.0, filed on Aug. 23, 2012, in the State Intellectual Property Office of the People's Republic of China, the disclosure of which is incorporated herein in its entirety by reference.

### BACKGROUND OF THE INVENTION

1. Field of the Invention

The present invention relates to a navigation system, and more particularly to the location-based service navigation system and a navigation display method thereof.

2. Description of Related Art

A stranger cannot find desired places or obtain desired information quickly when the stranger first comes to a more complicated indoor environment (such as a shopping mall or an airport) or a small region (such as a community or a theme park).

In a traditional method, regional map information is provided, but it is necessary for a user to go to the scene to observe the place. To provide eye-catching information, a map is checked through the Internet in advance since the quantity of information provided by the map is little, or passers-by and stores are asked to obtain detailed information. However, this method cannot be achieved easily in the complicated indoor environment, and generally takes much time to search for the desired information. In addition, information of large indoor buildings are generally labeled by broadcast, text signs or banners, but this labeling method also can provide little information and usually attract people to come over only, and a large quantity of information must be obtained from other places.

Large advertising or eye-catching signs are used to tell people about sales activities or information of a general shopping mall or a department store, and this method delivers a large quantity of information in the same region. Large indoor sites including airports or stadiums generally use electronic billboards to display information. However, this method also can provide little information and fails to inform all people about a large quantity of information within a short time.

In outdoor environments, a global positioning system (GPS) has overcome the positioning problem more successfully, and a GPS receiver is usually used to measure the time difference (TDOA) between arrived signals coming from 5 to 24 satellites to estimate positions, so as to provide a global positioning coverage. In indoor environments, the GPS fails to achieve the positioning effect since the satellite signals are blocked by the indoor environments. In a mobile phone base station positioning technology without any assistance from the GPS, the precision depends on the distribution and coverage of base stations. However, this method has the drawbacks of a slower positioning speed and a large error.

As wireless communication and wireless sensor network technology advance, the LBS becomes increasingly more important.

Therefore, it is an urgent issue for related designers to design a navigation system and a navigation display method to obtain information of a user's position and a map, so as to obtain more information and map screens.

### SUMMARY OF THE INVENTION

In view of the aforementioned problem of the prior art, it is a primary objective of the present invention to provide a navigation system and a navigation display method thereof, and the navigation system has the functions of providing local information and an indoor map by the location-based service (LBS).

To achieve the foregoing objective, the present invention provides a location-based service navigation system comprising a storage module, a processing module and a display module. The storage module stores a local characteristic point, and one of a current characteristic image, a current characteristic code or a piece of local information with a command string. The processing module compares the local characteristic point with one of the local information, the current characteristic image and the current characteristic code to analyze a current position. The display module displays the current position or the local information.

Wherein, the location-based service navigation system further comprises a transmitting module that receives the local information.

Wherein, the location-based service navigation system further comprises an image capture unit that captures the current characteristic image.

Wherein, the location-based service navigation system further comprises an input unit that receives the current characteristic code inputted by a user.

Wherein, the processing module analyzes the command string of the local information to sequentially draw an indoor map, and the display module displays the indoor map.

To achieve the foregoing objective, the present invention further provides a navigation display method applied in a navigation system, and the navigation system comprises a storage module, a processing module and a display module, and the navigation display method comprises the steps of: providing the storage module to store a local characteristic point, and one of a current characteristic image, a current characteristic code and a piece of local information with a command string; using the processing module to compare the local characteristic point with one of the local information, the current characteristic image and the current characteristic code to analyze a current position; and using the display module to display the current position or the local information.

In summation, the location-based service navigation system and the navigation display method of the present invention have one or more of the following advantages:

(1) The navigation system and the navigation display method thereof of the present invention provide information required by users through a quick search.

(2) The navigation system and the navigation display method thereof of the present invention work together with an outdoor positioning system, so as to provide navigation services for both indoor and outdoor environments.

(3) The navigation system and the navigation display method thereof of the present invention allow users to obtain more LBS information such as advertising or train/flight information of the users' position.

The foregoing and other objectives, technical characteristics and advantages of the present invention will become apparent with the detailed description of preferred embodiments accompanied with related drawings as follows.

### BRIEF DESCRIPTION OF THE DRAWINGS

FIG. 1 is a block diagram of a navigation system in accordance with a first preferred embodiment of the present invention;

FIG. 2 is a first schematic view of a navigation system in accordance with the first preferred embodiment of the present invention;

FIG. 3 is a second schematic view of a navigation system in accordance with the first preferred embodiment of the present invention;

FIG. 4 is a flow chart of a navigation display method in accordance with the first preferred embodiment of the present invention;

FIG. 5 is a block diagram of a navigation system in accordance with a second preferred embodiment of the present invention;

FIG. 6 is a first schematic view of a navigation system in accordance with the second preferred embodiment of the present invention;

FIG. 7 is a second schematic view of a navigation system in accordance with the second preferred embodiment of the present invention; and

FIG. 8 is a flow chart of a navigation display method in accordance with the second preferred embodiment of the present invention.

### DETAILED DESCRIPTION OF THE PREFERRED EMBODIMENTS

The technical characteristics of the location-based service system and the navigation display method thereof will become apparent with the detailed description of preferred embodiments accompanied with related drawings as follows. It is noteworthy to point out that same numerals are used for representing the same respective elements in the following embodiments.

The navigation system of the present invention is applicable for a personal digital assistant (PDA), a mobile phone, a global positioning system (GPS) or a personal computer (PC). To facilitate describing the technical characteristics of the present invention, a smartphone is used as an example in the following preferred embodiments, but the invention is not limited to smartphones only.

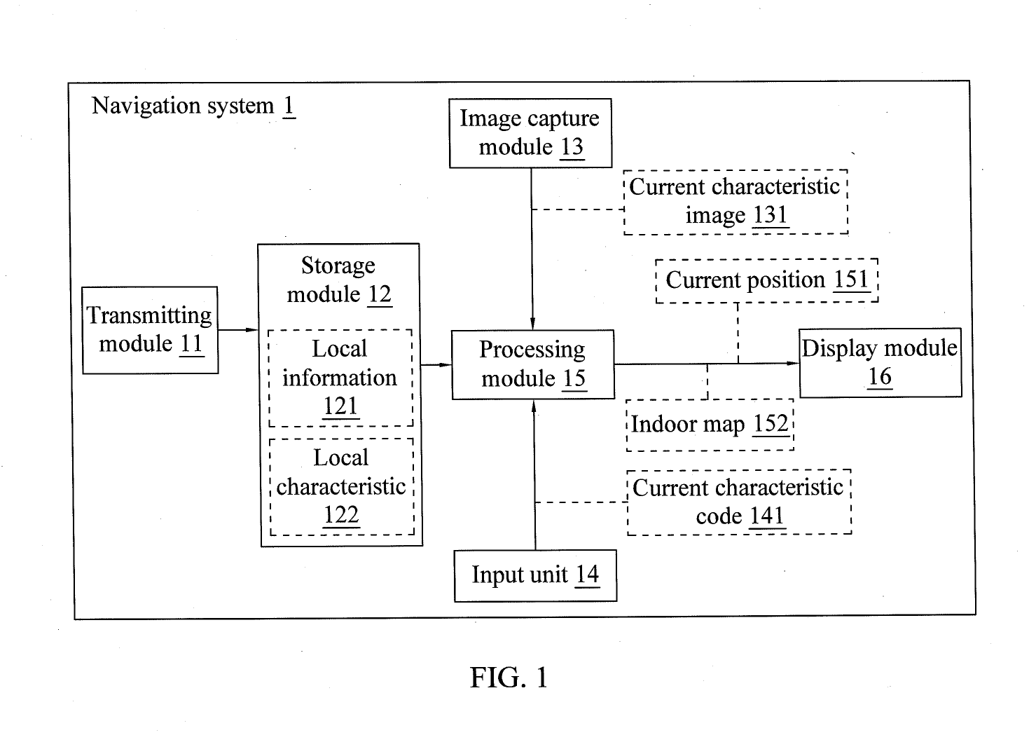

With reference to FIG. 1 for a block diagram of a navigation system in accordance with a first preferred embodiment of the present invention, the navigation system 1 comprises a transmitting module 11, a storage module 12, an image capture module 13, an input unit 14, a processing module 15 and a display module 16. The transmitting module 11 can receive local information 121 through a wireless or cable transmission, and the cable transmission can perform a download via a network, and the wireless transmission can perform operations of 3G and GSM mobile phone network, or LAN such as BT and Wi-Fi broadcasts. The storage module 12 can use a command string to store local information 121 and a local characteristic point 122. The image capture module 13 can capture a plurality of current characteristic images 131 and comprises a light sensor, a lens and a lens module. The input unit 14 can receive a current characteristic code 141 inputted by a user. The processing module 15 can be a central processing unit (CPU) or a micro-processing unit that analyzes the command string of the local information 121 to sequentially draw an indoor map 152, and the processing module 15 compares the local characteristic point 122 with the local information 121 to analyze a current position 151. The processing module 15 can compare the current characteristic image 131 captured by the image capture module 13 with the local characteristic point 122 to analyze the current position 151. Alternatively, the input unit 14 receives the current characteristic code inputted by a user 141 and uses the processing module 15 to analyze the current characteristic code 141 and the local characteristic point 122 to search the current position 151. The display module 16 can be a liquid crystal display (LCD) or a touch panel electrically coupled to the processing module 15 for displaying the local information 121, the current position 151 and the indoor map 152.

For indoor environments, the command string can be “English Command+Length/Width/Height parameters+Door/Window Position Coordinates+Local Characteristic Point”. Wherein, the local characteristic point 122 can be a sign used for path planning and road identification. For example, the local characteristic point 122 can be command string of “English Command+Local Information”, such as “English Command+Shop”, “English Command+Product Type”, “English Command+Price Change” or “English Command+Activity Mode”, and the command string is not limited to those described here only. The navigation system 1 can sequentially draw the indoor map 152 through the processing module 15 according to the command string. The navigation system 1 bases on different buildings to store different local characteristic points 122 by the storage module 12 and further uses the same format to store information to enhance the compatibility of various different electronic products.

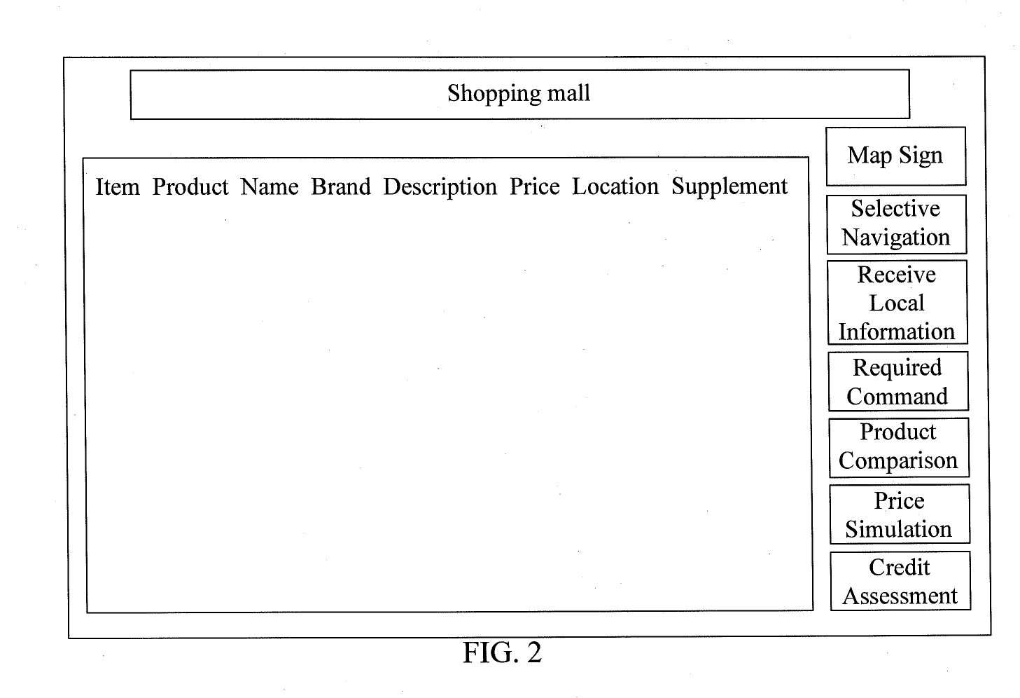

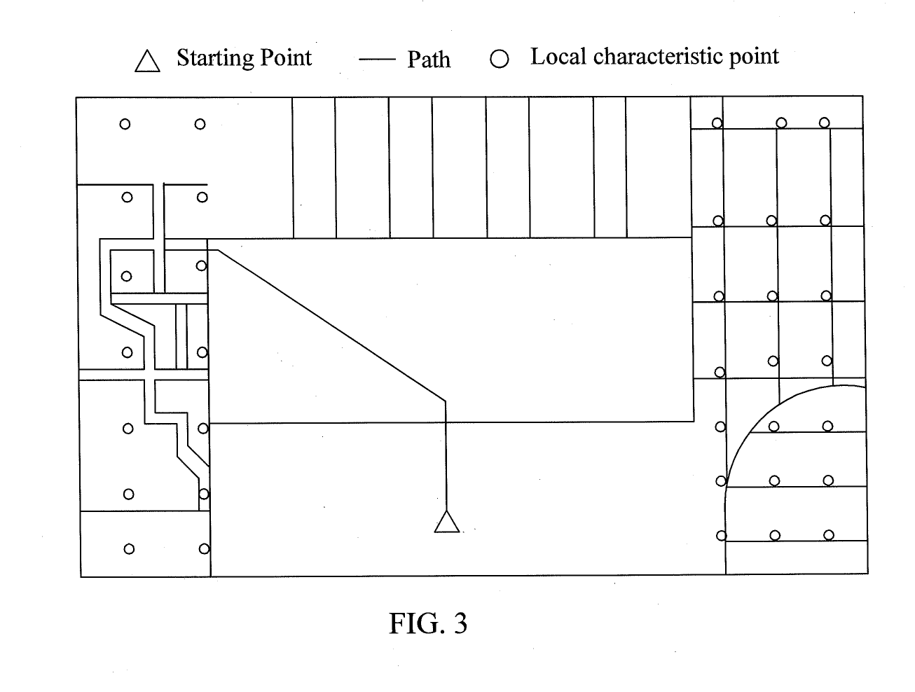

With reference to FIGS. 2 and 3 for the first and second schematic views of a navigation system in accordance with the first preferred embodiment of the present invention respectively, when a user holds a smartphone and enters into a region (such as a shopping mall), an indoor map of the shopping mall is obtained firstly, wherein the indoor map provides information inside the building, or when the user enters or passes through the region, a processing module of the smartphone obtains the indoor maps based on the local information or the local characteristic point stored according to the command string. In FIG. 2, a cable or wireless transmission is further provided for receiving the local information in the region, so that when the user passes through a commercial area or a large shopping mall, the user can receive a large quantity of commercial information such as product comparison, price simulation or credit evaluation without actually entering into the shopping mall, so as to save the time for making choices. On the other hand, the information received by the smartphone can be used as a basis for comparing the products, so as to provide a very convenient application.

For example, a user in an airport can use the navigation system of the present invention to download an internal airport map via the Internet or receive updated airport map or flight information in the airport.

In addition, the user can use the image capture module to capture a current characteristic image. For example, the user can take a picture of a shop logo, and the processing module compares the shop logo with a local characteristic point stored by the storage module to analyze a current position and determine the user's indoor position. Alternatively, the user can use the input module to receive a current characteristic code inputted by the user, wherein the current characteristic code can be a barcode or an alphanumeric serial number. The user's current position can be analyzed and found by using the processing module to compare the barcode or alphanumeric serial number with the local characteristic point.

In FIG. 3, it is noteworthy that the processing module can analyze the local characteristic point and the image or characteristic codes according to the image captured by the image capture module or the characteristic code inputted by the input module, so as to analyze a path from a starting point to a desired destination. And then, the processing module computes path planning to provide path information required by the user. For example, the user obtains information about promotion activities of the current shopping mall which is the local characteristic point in the region through a wireless/cable connection method when the user is in a large shopping mall. The user can further look for a merchant by the indoor positioning method or go to the site having the promotion activity according to the path planning.

Even though the concept of the navigation display method of the present invention has been described in the section of the navigation system of the present invention already, the following flow chart is provided for illustrating the present invention more clearly.

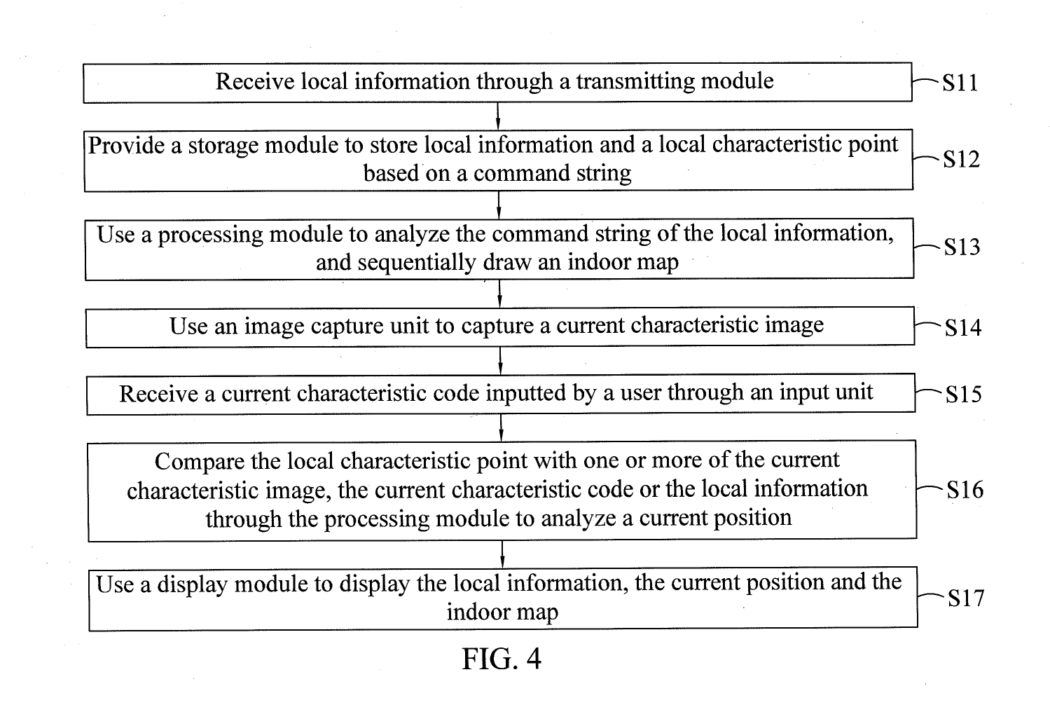

With reference to FIG. 4 for a flow chart of a navigation display method in accordance with the first preferred embodiment of the present invention, the navigation display method is applied in a navigation system, wherein the details of the navigation system has been described above, and thus will not be repeated. In FIG. 4, the navigation display method of the navigation system comprises the following steps:

S11: Receive local information through a transmitting module.

S12: Provide a storage module to store local information and a local characteristic point based on a command string.

S13: Use a processing module to analyze the command string of the local information, and sequentially draw an indoor map.

S14: Use an image capture unit to capture a current characteristic image.

S15: Receive a current characteristic code inputted by a user through an input unit.

S16: Compare the local characteristic point with one or more of the current characteristic image, the current characteristic code or the local information through the processing module to analyze a current position.

S17: Use a display module to display the local information, the current position and the indoor map.

The details and implementation method of the navigation display method of the navigation system in accordance with the present invention have been described in the section of the navigation system, and thus will not be repeated.

Based on the first preferred embodiment, the present invention further provides a second preferred embodiment for further illustration.

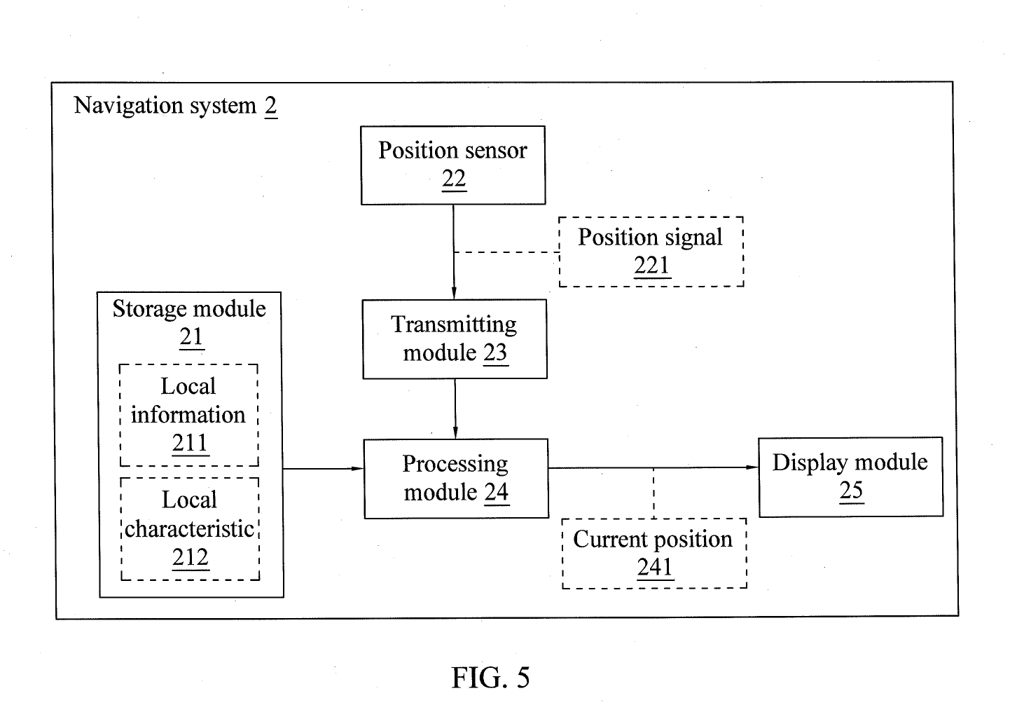

With reference to FIG. 5 for a block diagram of a navigation system in accordance with the second preferred embodiment of the present invention, the navigation system 2 comprises a storage module 21, a plurality of position sensors 22, a transmitting module 23, a processing module 24 and a display module 25. The storage module 21 can store local information 211 and a local characteristic point 212 based on a command string. The position sensor 22 can emits a plurality of position signals 221. The transmitting module 23 can receive a plurality of position signals 221. The processing module 24 can be a central processing unit (CPU) or a micro-processing unit that analyzes the command string of the local information 211 to sequentially draw an indoor map, and the processing module 24 compares the local characteristic point 212 with the local information 211 to analyze a current position 241, wherein the local information 211 and the position signal 221 are analyzed to obtain a current position 241. The display module 25 can be a liquid crystal display (LCD) or a touch panel electrically coupled to the processing module 24 for displaying the local information 211, the current position 241 and the indoor map. Wherein, the position sensor 22 can be a sensor having a wireless transceiver function and simple processing functions, and a merchant can installed several low-power position sensors 22 with the transceiver function at cutoff points, and a battery or a power grid is provided for supplying required power to the position sensors.

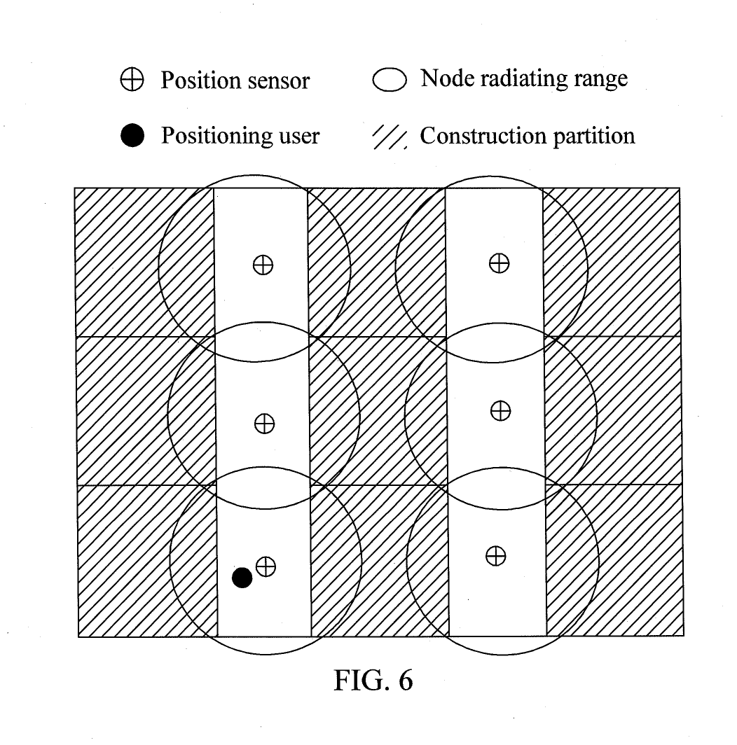

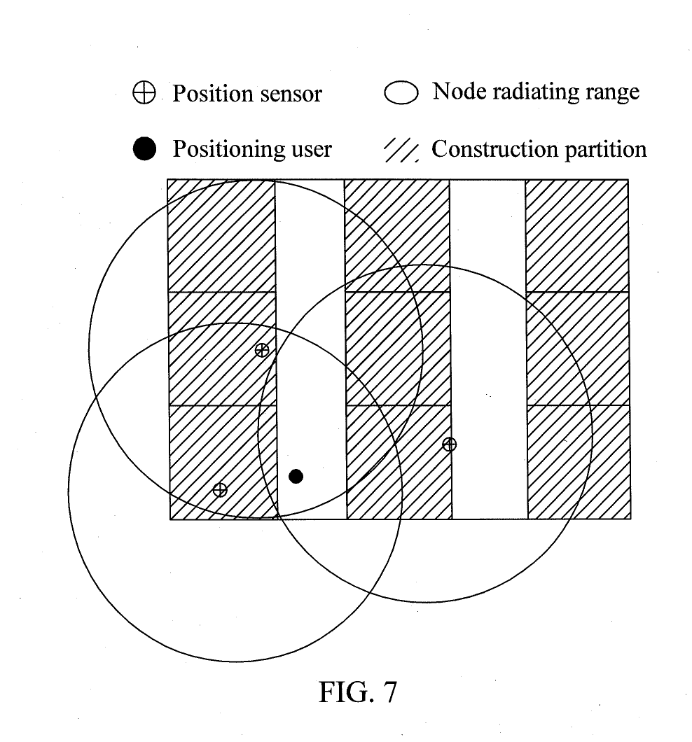

With reference to FIGS. 6 and 7 for the first and second schematic vies of a navigation system in accordance with the second preferred embodiment of the present invention respectively, the position sensor as shown in FIG. 6 can broadcast current 2D position information in a small region. Since each position sensor has a node radiating range, therefore the user can use to receive position signals received by the transmitting module of the navigation system within the node radiating range, and the processing module analyzes the position signal and the indoor map or the internal structure of the building to obtain the current position of a positioning user. The actual position can be confirmed by an inertia navigation system. It is noteworthy that the larger the quantity of position sensors, the higher is the precision of the positioning. In addition, the position sensor can monitor the request for position information and acknowledge the current position information, and the position information request can be issue manually or automatically from a handheld terminal. In FIG. 7, if the navigation system of the positioning user receives several position signals from several position sensors simultaneously, it shows that the positioning user is situated at a common point of several positions.

To reduce the quantity of sensors and the level of difficulty, a mobile phone base station with a less number of installed position sensors can be used. Each floor of a building can be divided into a plurality of adjacent regions, and each sensor is responsible for monitoring and acknowledging the position information in each region.

The monitoring coverage of the sensor is slightly greater than the region. Alternatively, each floor is divided into a plurality of points according to the 2D coordinates, and the coordinates of each point are confirmed. These coordinates must be stored in the handheld terminals at the same time. In the meantime, any point of a floor must be situated within the monitoring coverage of at least three sensors. The handheld terminal issues a position information request manually or automatically and receives an acknowledge signal. The acknowledge signal must include the serial number of the position sensor and the time that receivers the position information request. The handheld terminal computes the current position according to the received acknowledged information of the sensors.

Even though the concept of the navigation display method of the present invention has been described in the section of the navigation system of the present invention already, the following flow chart is provided for illustrating the present invention more clearly.

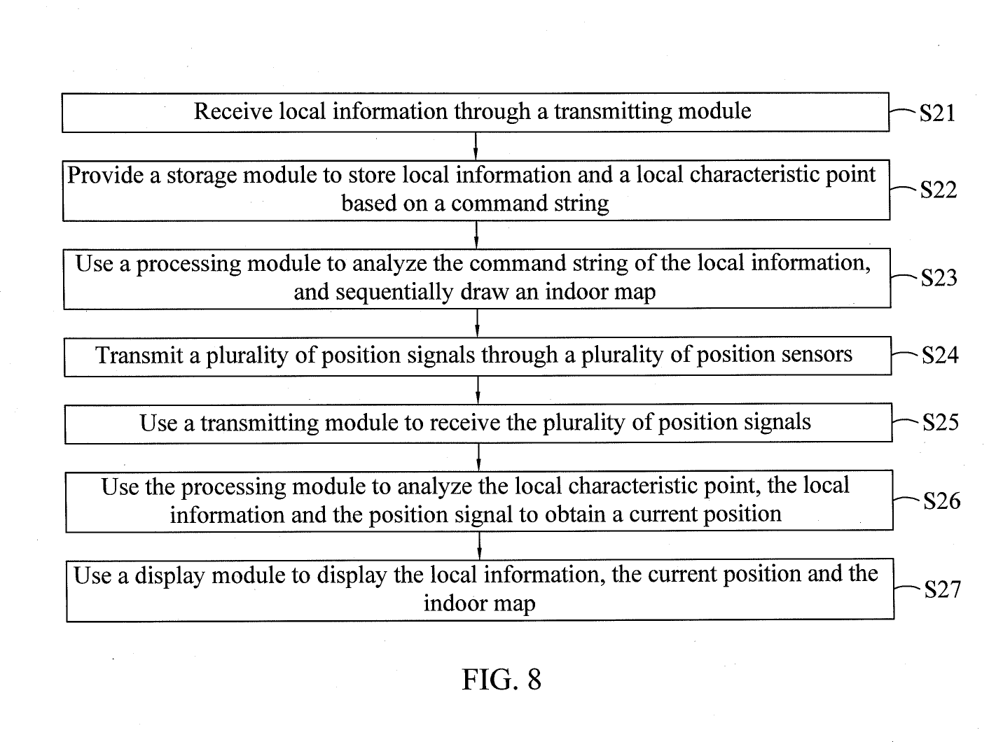

With reference to FIG. 8 for a flow chart of a navigation display method in accordance with the second preferred embodiment of the present invention, the navigation display method is applied in a navigation system, wherein the details of the navigation system have been described above, and thus will not be repeated. In FIG. 8, the navigation display method of the navigation system comprises the following steps:

S21: Receive local information through a transmitting module.

S22: Provide a storage module to store local information and a local characteristic point based on a command string.

S23: Use a processing module to analyze the command string of the local information, and sequentially draw an indoor map.

S24: Transmit a plurality of position signals through a plurality of position sensors.

S25: Use a transmitting module to receive the plurality of position signals.

S26: Use the processing module to analyze the local characteristic point, the local information and the position signal to obtain a current position.

S27: Use a display module to display the local information, the current position and the indoor map.

The details and implementation method of the navigation display method of the navigation system in accordance with the present invention have been described in the section of the navigation system, and thus will not be repeated.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A location-based service (LBS) navigation system, comprising:
a storage module, storing a local characteristic point, and one of a current characteristic image, a current characteristic code or a piece of local information with a command string;
a processing module, comparing the local characteristic point with one of the local information, the current characteristic image and the current characteristic code to analyze a current position; and
a display module, displaying the current position or the local information.

2. The location-based service navigation system of claim 1, further comprising a transmitting module that receives the local information.

3. The location-based service navigation system of claim 1, further comprising an image capture unit that captures the current characteristic image.

4. The location-based service navigation system of claim 1, further comprising an input unit that receives the current characteristic code inputted by a user.

5. The location-based service navigation system of claim 1, wherein the processing module analyzes the command string of the local information to sequentially draw an indoor map, and the display module displays the indoor map.

6. A navigation display method, applied in a navigation system, and the navigation system comprising a storage module, a processing module and a display module, and the navigation display method comprising the steps of:
providing the storage module to store a local characteristic point, and one of a current characteristic image, a current characteristic code and a piece of local information with a command string;
using the processing module to compare the local characteristic point with one of the local information, the current characteristic image and the current characteristic code to analyze a current position; and
using the display module to display the current position or the local information.

7. The navigation display method of claim 6, further comprising the step of receiving the local information through a transmitting module.

8. The navigation display method of claim 6, further comprising the step of using an image capture unit to capture the current characteristic image.

9. The navigation display method of claim 6, further comprising the step of receiving the current characteristic code inputted by a user through an input unit.

10. The navigation display method of claim 6, further comprising the steps of:
using the processing module to analyze the command string of the local information to sequentially draw an indoor map; and
displaying the indoor map through the display module.
